(19) United States
(12) Patent Application Publication
(10) Pub. No.: US 2014/0281301 A1
(43) Pub. Date: Sep. 18, 2014

(54) ELASTIC HIERARCHICAL DATA STORAGE BACKEND

(71) Applicant: Silicon Graphics International Corp., Milpitas, CA (US)

(72) Inventors: Jose Antonio Reinoso, San Jose, CA (US); John Michael Sygulla, Chippewa Falls, WI (US); Floyd William Christofferson, Fremont, CA (US)

(73) Assignee: Silicon Graphics International Corp., Milpitas, CA (US)

(21) Appl. No.: 13/835,462

(22) Filed: Mar. 15, 2013

(51) Int. Cl. G06F 3/06

(52) U.S. Cl. CPC G06F 3/0647; G06F 3/0604; G06F 3/0683
USPC 711/161

(57) ABSTRACT

A multi-tiered data management system utilizes vertical storage tiers, each with one or more horizontal data storage elements, to provide a dynamic and configurable system for managing the storing, archiving and retrieval of data. The system provides an ability to automatically copy data in parallel to multiple types of storage systems horizontally within a tier and vertically between tiers transparently from the host system or user perspective. Users may decide how many backend systems would be utilized and managed, and provide information to define rules or policies for the movement of data into, and among, and from the backend systems and tiers of storage devices. Data is managed by these set policies and determines how long the data will stay in each medium, be migrated between mediums, and otherwise managed. When a user retrieves data, the present system determines which data storage source would best suit the user's request.

### BACKGROUND OF THE INVENTION

1. Field of the Invention

The present invention relates to hierarchical data storage systems. In particular, it relates to expanding tiers of a hierarchical data storage system.

2. Description of the Related Art

Enterprises are creating and processing more and more data. With the amount of data growing exponentially, enterprises cannot afford to handle data in traditional ways. In response to these growing data storage and management challenges, enterprises use techniques such as data compression to reduce the overall footprint of data, and also deploy additional primary disk drive storage capacity. But adding additional primary storage capacity becomes increasingly expensive to deploy as the volume of data increases, due to the additional equipment costs and the increasing complexity and administrative burden of data storage management. In addition to adding primary storage, enterprises often seek to preserve data in a way that is less costly by backing up or archiving important but infrequently used data files to tape, and then have these tapes put in vaults in remote locations. To recover data from these vaults, the data does not need to be in primary storage, but does need to be searchable and easily accessible without substantial time delays or administrative intervention. Previous data storage management and archiving systems do not provide flexible data management and fast, easy accessibility across multiple tiers of data storage.

With these ever growing data volumes, the increasing costs and complexity of primary storage, and tape archiving concerns, have increased flexibility as to what storage and archiving medium to use is important. What is needed is a data management system that is flexible, efficient, and overcomes the shortcomings of the prior art.

### SUMMARY OF THE CLAIMED INVENTION

The present invention provides a multi-tiered system having a vertical stack and horizontal tier elements for one or more levels of the stack to provide a dynamic and configurable system for storing data. The present system provides an ability to automatically copy data in parallel to multiple classes or tiers of storage devices. These multiple tiers may include any type of storage infrastructure, including primary or secondary disk or solid-state storage system, data tape, power-managed arrays of disks (MAID) and cloud-based storage. Users and/or IT administrators may decide how many of such backend systems would be utilized as well as managed, and provide information to define policies for the movement of data into, among, and from the backend systems and tiers of storage devices. The present system manages the data by these set policies and determines how long the data will stay in each medium, be migrated between mediums, and otherwise managed. When a user retrieves data, the present system determines which data storage source would best suit the user's request. The system identifies which medium the data is stored in and will recall the data from the medium available that can deliver within the shortest period of time or otherwise meet the user's needs.

An embodiment of the present invention archives data by first receiving data to be archived. The data is initially stored in each of one or more types of storage. A request is received for the data. A determination may be made automatically as to which storage type of the one or more storage types to retrieve the data from based on retrieval. The data is retrieved from one of the storage types of which the data was initially stored. The requested data is then transmitted.

### BRIEF DESCRIPTION OF THE DRAWINGS

FIG. 1 is a block diagram of a data backup system of the prior art.

FIG. 2A is a block diagram of a tiered data storage system.

FIG. 2AB is a block diagram of a data storage appliance.

FIG. 3 is a flowchart of a method for providing tiered data storage.

FIG. 4 is a flowchart of a method for applying policies to multiple types of storage.

FIG. 5 is a block diagram of a computing system for implementing the present invention.

### DETAILED DESCRIPTION

Embodiments of the present invention provide a multi-tiered system having a vertical stack and horizontal tier elements for one or more levels of the stack to provide a dynamic and configurable system for storing data. The present system provides an ability to automatically copy data in parallel to multiple classes or tiers of storage devices. These multiple tiers may include primary disk or solid-state storage systems, secondary disk systems, tape, power-managed arrays of disks (commonly known as MAID, or massive arrays of idling disks) and cloud-based storage. Users or IT administrators may decide how many of such backend systems would be utilized as well as managed, and provide information to define policies for the movement of data into, among, and from the backend systems and tiers of storage devices.

The data storage environment is decoupled and virtualized from a compute system which provides the data being stored. The data is stored in tiers which are decoupled from the compute system or host through a gateway. The gateway enforces policies to store the data, migrate the data, and retrieve the data when needed. From the compute system or host point of view, the storage system appears as a virtualization—the multiple vertical tiers with multiple horizontal elements are not known to the host. The host provides the data to the storage system, which appears as a single virtual system, and the gateway applies policies to determine where the file is stored in multiple vertical and horizontal elements.

In an embodiment, an application stored and executed on a gateway device receives data from a computer host or other block-based or file-based storage system, such that the data is to be stored in a multi-tiered data storage system. The gateway device application then stores the data on multiple storage types based on policies implemented by the gateway device application. The multiple storage types may be in the same tier or different tiers. When the data is requested from the storage system, the gateway application receives and parses the request, determines which storage device types in which tiers are storing the requested data and from which storage device the data should be retrieved. The data is retrieved, for example from the storage device type which provides the fastest response, and the requested data is provided to the requesting host. Sometimes the data is retrieved not from the fastest medium but from a medium that is less congested and would provide the fastest data retrieval.

The present system manages data by set policies. The policies may include rules and other information which determine how long the data will stay in each storage device type, be migrated between storage devices in different vertical tiers and horizontal tier elements, and otherwise be managed. Policies may be set, and overridden, by data users or administrators, may be automatically set based on defaults, or learned from behaviors and patterns of storage and requests with respect to the data.

The policies may be centrally implemented from a gateway or distributed among devices and systems within the data storage system. For example, the policies may be distributed to a particular device in each of a plurality of tiers having multiple device types, multiple devices in each tier, or selected devices only. The distributed policy may be used to manage data storage, movement and retrieval similar to how policies are implemented from a gateway.

The policies implemented by the present invention may be supplied through an application programming interface (API). The API may allow an external third-party automated computer system or administrator to create and adjust policies. The API may be hosted by a gateway and communicate with a gateway application or may be implemented on one or more storage devices or systems in the tiered system.

When a user retrieves data, the present system determines which data storage source would best suit the user's request. For example, when originally stored, the data may be stored in multiple locations, such as secondary tier storage device type and a primary tier storage device type. The system realizes which device type or medium the data is stored in and will recall the data from the medium available that can deliver within the shortest period of time or otherwise meet the user's needs.

FIG. 1 is a block diagram of a data backup system of the prior art. The prior art data backup system includes a data source 110, primary hard disk drive (HDD) storage 120, and tape storage 130. Data source 110 may implement the origination of data to be backed up in the data storage system of primary storage 120 and tape storage 130. The data source 110 may be implemented by a client computer, client servers, an intranet, and other data sources.

When data from data source 110 is stored by the data storage system of prior art systems, data is first stored in primary HD storage 120. This first tier of storage is used to store high priority data and provides very fast access. The first tier is expensive to maintain. As such, data characterized as low priority or otherwise without low-latency requirements may be migrated to tape storage 130. Tape storage provides a lower tier which is used to store data, and has slow access, but is relatively inexpensive to maintain. Unfortunately, some older forms of tape storage are not readable to modern tape devices, and retrievable of tape data can take hours or days.

The prior art features a one or two tiered system which may communicate and manage data storage only vertically between the two-tiers. The present invention distinguishes from the prior art by communicating and managing data storage broadly among different types of data storage systems both horizontally within a tier while also communicating and moving data vertically among two or more tiers of data storage. Hence, the primary HDD storage and tape storage communicate only with each other, and data may only be kept in one or the other system. Data is not stored in both the HDD storage and the tape storage in previous systems.

FIG. 2A is a block diagram of a tiered data storage system. The system of FIG. 2A includes computing device 210, network attached storage systems (NAS) 215, and storage area network (SAN) 220, block based storage 225, file-based storage 230, and object based storage 235. Computing device 210 may include one or more customer device. The NAS system 215 may include file level computer data storage and may also provide the initial sources of data to be stored on the data storage system. The block, file and object based storage system may include any device or system that stores data in blocks, files or object formats, respectively. The computing devices and systems communicate through a common internet file system (CIFS) and a network file system (NFS), or other standard protocol.

Devices and systems 210-235 may act as hosts to provide data to gateway 240 for storage in a data storage system and request data retrieval from gateway 240. Gateway 240 decouples and virtualizes the data storage system in which the data may be stored and retrieved for hosts 210-235. Though the system of FIG. 2 illustrates hosts of a computing device, NAS, SAN, blocks, files and objects, other host devices and systems can be used with the present technology.

Gateway 240 includes application 242 and may communicate with every storage device type, including devices and systems 250-280, in a tiered storage system. When data is provided by one of hosts 210-235 to the data storage system for storage, the data is initially received at gateway 240. Application 242 on gateway 240 identifies the received data, for example through meta-data associated with the data, and applies policies to determine where to store the data. Application 242 may initially store the data in a primary tier storage device and/or a secondary tier storage device. For example, policies enforced by application 242 may require that the data is initially stored at any or all of tape storage 260, MAID storage 270 or other power managed storage, and cloud storage 280. As such, gateway 240 may initially stores archived data on a plurality of vertical tiers and different storage types and systems forming horizontal tiers in each vertical tier. Gateway 240 may also apply a policy to the different storage tiers. The policy may involve how to manage data stored on the horizontal tiers, whether to maintain, migrate, or remove data from a particular tier, and other management functions. Gateway 240 also processes requests to access data from the archived data systems.

A primary tier may include faster and more expensive types of memory devices, such as for example hard disk drive (HDD) storage and solid state memory (SSD) storage devices. For each storage device type, more than one version of the device may be included in a horizontal tier. For example, in the primary tier, multiple versions of HDD storage devices are shown, fast HDD and faster HDD. In embodiments, the multiple versions may be implemented using different volumes of devices within the same storage enclosure or server.

The secondary tier may include slower and less expensive storage devices. For example, the secondary tier of FIG. 2A includes tape storage 260 and a massive array of idle disk (MAID) storage 270. Tape storage 260 may store data cheaply at a cost of slow access. MAID storage 270 may include standard disk storage and/or MAID. MAID functionality provides data storage at a slightly slower access time than primary tier storage. The idle disks of MAID storage 270 are typically only spun up on demand, and provide a reduced power option for storing data. Cloud storage data may include networked online storage which includes data stored in virtualized pools. The cloud storage 280 may be implemented by the same provider of the gateway 240 or by third party hosting companies.

Cloud storage 280 may provide another horizontal element within the primary tier and the secondary tier. Cloud storage 280 may provide additional storage over a network, and may include several types of storage, including HDD, SSD, MAID, tape and other storage types and systems.

Each of the storage system types 250-280 may communicate with each other and with gateway 240. As such, data management policy may be implemented on the gateway to maintain and modify data storage parameters vertically between storage tiers and within the horizontal tiers in a way that is transparent to the user. In embodiments, the data policy may be distributed over one or more storage device types. For example, cloud storage 280 may include a set of policies that it uses to store and migrate data between devices that make-up the cloud storage.

FIG. 2B is a block diagram of a data storage appliance. The storage appliance of FIG. 2B includes gateway 240, faster HDD 250, fast HDD 252, and SSD storage 254, all contained on a single appliance. The single appliance may implement both the gateway and one or more storage device types of a primary tier. The compliance may include devices and components typically found in a computing device, such as those discussed with respect to FIG. 5, and a plurality of storage devices. The appliance may be a rack mountable computing device which receives data and distributes data according to set policies. In operation, the appliance of FIG. 2B may temporarily store data received from a host device in one or more of storage 250-254, such that the storage is used as a cache. Policy engine 242 may then apply policies to the stored data to distribute the data to other tiers.

FIG. 3 is a flowchart of a method for providing tiered data storage. First, data is received to be stored at step 310. The data may be received by gateway from one of hosts 210-230.

Data may initially be stored in multiple types of storage devices at step 320. In some embodiments, the data may be stored in one or more vertical tiers having a plurality of horizontal storage device types by the gateway. The plurality of vertical tiers and horizontal elements may include storage types of HDD, SSD, tape storage, MAID storage, cloud storage and other storage. In some embodiments, per policy provided by the customer administrators, the data received may initially be installed in multiple types of storage, but less than all of the storage types. For example, data may initially be stored in only tape storage and MAID storage, and therefore not maintained in cloud storage.

Policies may be applied to the stored data in multiple storage types at step 330. The policies may be applied from gateway 240 and at each storage type location. Hence, the policies may be implemented between a gateway and the individual storage types. An application on the gateway may scan file systems and maintain a database of what is on each system, as well as how the overall policies impact data on those devices. The policies may be applied to migrate, remove, duplicate, and otherwise manage data based on events such as time, user ID, project ID, last access, and other information. Applying policies is discussed in more detail below with respect to the method of FIG. 4. A request may be received for data at step 340. The request may involve a customer request to access data which is archived in the data storage system.

The storage type to retrieve the data from may be identified at step 350. In some embodiments, the request may specify that the data is needed as fast as possible, or the data is needed as cheaply as possible. In any case, the intelligence at gateway 240 may identify where the data is presently available from and how long it will take to retrieve the data. For example, although the data may initially have been stored in all available horizontal tiers of storage, the policy associated with the data may have specified that data be removed from one or more storages after a period of time. For example, if data was initially stored in tape storage and MAID storage, but the policy indicated that the data should be removed from the MAID storage after 60 days, a request received at 30 days will most likely retrieve the data from MAID storage while a request for the data received after 90 days will retrieve the data from tape storage, thus releasing the data blocks in the other tiers to be overwritten by other data.

Data is retrieved from the identified storage type at step 360. The requested data is then transmitted to the requester at step 370.

FIG. 4 is a flowchart of a method for applying policies to multiple types of storage. First, data policies are received from an administrator at step 410. The data policies may be received with the data or at some other time. For example, the administrator may initially provide a first set of policies, and then receive data in an ongoing process. In some embodiments, the administrator may update the policies for data which is already archived by the data storage system hence receiving data policies may occur over a period of time before or after data is received from the customer to store in the data storage system. The policy data received may be stored in gateway as well as distributed over the horizontal tiers of the data storage system.

The policies may be applied to data in tape storage at 420. Applying policies to tape storage may include when to store data for example at initial receipts of the data or later, when to remove data, and when to migrate the data to other storage tiers. Policies may be applied to data in MAID storage at step 430. MAID storage policies may include duplicating the data, migrating the data, removing the data and other operations to perform on the data. These policies may also be applied to data in cloud storage at step 440.

FIG. 5 is a block diagram of a computing system for implanting the present invention. System 500 of FIG. 5 may be implemented in the contexts of the likes of computing devices which implement all or a part of computing device 210, NAS 215, SAN 220, block-based storage 225, file-based storage 230, object based storage 235, gateway 240, storage systems 254-252, tape storage 260, MAID storage 270, and cloud storage 280. The computing system 500 of FIG. 5 includes one or more processors 510 and memory 520. Main memory 520 stores, in part, instructions and data for execution by processor 510. Main memory 520 can store the executable code when in operation. The system 500 of FIG. 5 further includes a mass storage device 530, portable storage medium drive(s) 540, output devices 550, user input devices 560, a graphics display 570, and peripheral devices 580.

The components shown in FIG. 5 are depicted as being connected via a single bus 590. However, the components may be connected through one or more data transport means. For example, processor unit 510 and main memory 520 may be connected via a local microprocessor bus, and the mass storage device 530, peripheral device(s) 580, portable storage device 540, and display system 570 may be connected via one or more input/output (I/O) buses.

Mass storage device 530, which may be implemented with a magnetic disk drive or an optical disk drive, is a non-volatile storage device for storing data and instructions for use by processor unit 510. Mass storage device 530 can store the system software for implementing embodiments of the present invention for purposes of loading that software into main memory 510. Mass storage 530 may include SDD storage, HDD Storage, Tape storage, MAID storage, and other types of storage devices.

Portable storage device 540 operates in conjunction with a portable non-volatile storage medium, such as a floppy disk, compact disk or Digital video disc, to input and output data and code to and from the computer system 500 of FIG. 5. The system software for implementing embodiments of the present invention may be stored on such a portable medium and input to the computer system 500 via the portable storage device 540.

Input devices 560 provide a portion of a user interface. Input devices 560 may include an alpha-numeric keypad, such as a keyboard, for inputting alpha-numeric and other information, or a pointing device, such as a mouse, a trackball, stylus, or cursor direction keys. Additionally, the system 500 as shown in FIG. 5 includes output devices 550. Examples of suitable output devices include speakers, printers, network interfaces, and monitors.

Display system 570 may include a liquid crystal display (LCD) or other suitable display device. Display system 570 receives textual and graphical information, and processes the information for output to the display device.

Peripherals 580 may include any type of computer support device to add additional functionality to the computer system. For example, peripheral device(s) 580 may include a modem or a router.

The components contained in the computer system 500 of FIG. 5 are those typically found in computer systems that may be suitable for use with embodiments of the present invention and are intended to represent a broad category of such computer components that are well known in the art. Thus, the computer system 500 of FIG. 5 can be a personal computer, hand held computing device, telephone, mobile computing device, workstation, server, minicomputer, mainframe computer, or any other computing device. The computer can also include different bus configurations, networked platforms, multi-processor platforms, etc. Various operating systems can be used including Unix, Linux, Windows, Macintosh OS, Palm OS, and other suitable operating systems.

The foregoing detailed description of the technology herein has been presented for purposes of illustration and description. It is not intended to be exhaustive or to limit the technology to the precise form disclosed. Many modifications and variations are possible in light of the above teaching. The described embodiments were chosen in order to best explain the principles of the technology and its practical application to thereby enable others skilled in the art to best utilize the technology in various embodiments and with various modifications as are suited to the particular use contemplated. It is intended that the scope of the technology be defined by the claims appended hereto.

What is claimed is:

1. A method for archiving data, comprising:
receiving data to be archived;
initially storing the data in each of two or more types of storage devices within a storage system,
the storage system including multiple tiers of storage, each tier including multiple types of storage devices.

2. The method of claim 1, further comprising:
receiving a request for the data;
automatically determining which storage type of the two or more storage types to retrieve the data from;
retrieving the data from one of the two or more storage types of which the data was initially stored; and
transmitting the requested data.

3. The method of claim 1, further comprising modifying the storage of the data in at least one of the two or more types of storage based on a policy associated with the data.

4. The method of claim 3, wherein the policy requires changes to be made to storage of the data after a period of time.

5. The method of claim 3, wherein the policy requires changes to be made to storage of the data based on an entity identifier associated with the data.

6. The method of claim 1, further comprising determining which storage type of the two or more types of storage the requested data could be retrieved from in the shortest period of time.

7. The method of claim 1, further comprising providing a confirmation to a user that the received data is archived, the confirmation not indicating that the received data was stored in two or more types of storage.

8. A computer readable non-transitory storage medium having embodied thereon a program, the program being executable by a processor to perform a method for archiving data, the method comprising:
receiving data to be archived;
initially storing the data in each of two or more types of storage devices within a storage system,
the storage system including multiple tiers of storage, each tier including multiple types of storage devices.

9. The computer readable non-transitory storage medium of claim 8, the method further comprising:
receiving a request for the data;
automatically determining which storage type of the two or more storage types to retrieve the data from;
retrieving the data from one of the two or more storage types of which the data was initially stored; and
transmitting the requested data.

10. The computer readable non-transitory storage medium of claim 8, further comprising modifying the storage of the data in at least one of the two or more types of storage based on a policy associated with the data.

11. The computer readable non-transitory storage medium of claim 11, wherein the policy requires changes to be made to storage of the data after a period of time.

12. The computer readable non-transitory storage medium of claim 11, wherein the policy requires changes to be made to storage of the data based on an entity identifier associated with the data.

13. The computer readable non-transitory storage medium of claim 8, further comprising determining which storage type of the two or more types of storage the requested data could be retrieved from in the shortest period of time.

14. The computer readable non-transitory storage medium of claim 8, further comprising providing a confirmation to a user that the received data is archived, the confirmation not indicating that the received data was stored in two or more types of storage.

15. A system for archiving data, the system comprising:
a processor;
memory;
one or more modules stored in the memory and executable by the processor to:
receiving data to be archived;
initially storing the data in each of two or more types of storage devices within a storage system,
the storage system including multiple tiers of storage, each tier including multiple types of storage devices.

16. The system of claim 15, wherein the one or more modules are executable to:
receiving a request for the data;
automatically determining which storage type of the two or more storage types to retrieve the data from;
retrieving the data from one of the two or more storage types of which the data was initially stored; and
transmitting the requested data.

17. The system of claim 15, further comprising modifying the storage of the data in at least one of the two or more types of storage based on a policy associated with the data.

18. The system of claim 17, wherein the policy requires changes to be made to storage of the data after a period of time.

19. The system of claim 17, wherein the policy requires changes to be made to storage of the data based on an entity identifier associated with the data.

20. The system of claim 15, further comprising determining which storage type of the two or more types of storage the requested data could be retrieved from in the shortest period of time.
